(19) United States
(12) Patent Application Publication
(10) Pub. No.: US 2006/0104614 A1
(43) Pub. Date: May 18, 2006

(54) Method and apparatus for writing information on picture data sections in a data stream and for using the information

(76) Inventor: Sung Wan Park, Suwon-si (KR)

Correspondence Address: HARNESS, DICKEY & PIERCE, P.L.C., P.O. BOX 8910, RESTON, VA, 20195, US

(21) Appl. No.: 11/271,829

(22) Filed: Nov. 14, 2005

(30) Foreign Application Priority Data
Nov. 15, 2004 (KR) 10-2004-0093116

(51) Int. Cl. H04N 5/781

(52) U.S. Cl. 386/95; 386/125

(57) ABSTRACT

When recording video data in a plurality of recording blocks on a recording medium while organizing the video data into navigation units, the present invention records the size of the first picture data in each of the navigation units expressed in terms of the number of transport packets carrying the first picture data. Alternatively, the present invention adds 128-byte header information to each of the recording blocks, in which case if a recording block contains the last data of the first picture in each of the navigation units, position information for indicating the end position is written in the header information. The present invention thereby can specify-the data section of the first picture in each navigation unit precisely.

### BACKGROUND

1. Field

The document relates to a method and apparatus for recording information on picture data sections carried in a sequence of input transport packets when recording video data and for identifying picture data from the recorded transport packets based on the recorded information.

2. Description of the Related Art

Optical disks as a new recording medium for recording video signals have replaced magnetic tapes. The DVD±R is a representative rewritable optical disk on which video data of up to 6 hours of playback time can be recorded.

TV stations currently broadcast in both analog and digital but only digital TV broadcast will be available in the near future. Digital broadcast provides better video quality over analog broadcast. To record digital TV signals, new recording media having larger storage capacity than DVD±R are required.

For this reason, higher-capacity optical disks are under development. When recording a digital broadcast data stream on a rewritable disk (e.g., DVD±R or higher-capacity disk), the recording apparatus organizes the broadcast data into navigation units for managing playback of the recorded data. The size of a navigation unit is usually not the same as the size of a recording block of the recording medium. Therefore, an effective method for handling problems caused by the size difference is required.

### SUMMARY OF THE INVENTION

It is an object of the present invention to provide a method and apparatus for creating and recording management information on the misalignment between navigation units and recording blocks and management information for specifying the data section of the first picture in each of the navigation units.

It is another object of the present invention to provide a method and apparatus for accessing each navigation unit and the first picture therein using the recorded management information.

When recording video data in a plurality of recording blocks on a recording medium while organizing the video data into navigation units, the present invention records the size of the first picture data in each of the navigation units expressed in terms of the number of transport packets carrying the first picture data.

When recording video data in a plurality of recording blocks on a recording medium while organizing the video data into navigation units, the present invention adds header information of a predefined length to the top of each of the recording blocks. If a recording block contains the last data of the first picture in a navigation unit, position information on the last data is recorded in the header information of the recording block.

In one embodiment of the invention, the information on the size of the first picture data in each navigation unit is recorded together with the position of the first packet carrying the navigation unit, the size of the navigation unit, and the presentation time information of the navigation unit.

In the embodiment, the size information is recorded as 23-bit data and is set to 0 if the size of the first picture is unknown.

In another embodiment, each recording block comprises 170 transport packets and the position information on the last data has a value between 1 and 170.

In yet another embodiment, the position information included in the header of a recording block is set to θ if the recording block does not contain the first picture data in a navigation unit.

### BRIEF DESCRIPTION OF THE DRAWINGS

The accompanying drawings, which are included to provide a further understanding of the invention, illustrate the preferred embodiments of the invention, and together with the description, serve to explain the principles of the present invention.

In the drawings:

FIG. 1 illustrates the structure of a sequence of HD-DVD transport packets;

FIG. 2 illustrates the relation between navigation units and packet groups of video data recorded on the HD-DVD;

FIG. 3 illustrates an example of information for specifying the position relation between a stream object and packet groups;

FIG. 4 illustrates an example of information for specifying the position relation between the first I-picture in a navigation unit and packet groups;

FIG. 5 illustrates the structure of a time map assigned to each navigation unit;

FIG. 6 illustrates the structure of a time map assigned to each navigation unit in accordance with one embodiment of the present invention;

FIG. 7 illustrates an example in which the size of the first picture in a stream object unit (SOBU) is indicated by the information shown in FIG. 6;

FIG. 8 illustrates general information in the header information assigned to each recording block of the HD-DVD in accordance with another embodiment of the present invention;

FIG. 9 illustrates an example in which the end position of the first picture in a navigation unit is indicated by the information shown in FIG. 8;

FIGS. 10 and 11 illustrate examples of the general information assigned to each recording block of the HD-DVD in accordance with other embodiments of the present invention;

FIG. 12 illustrates a block diagram of an optical disk recording/reproducing apparatus in accordance with the present invention; and

FIG. 13 illustrates an example in which the transport packets carrying the first picture data of a navigation unit are identified exactly.

### DETAILED DESCRIPTION OF THE PREFERRED EMBODIMENTS

In order that the invention may be fully understood, preferred embodiments thereof will now be described with reference to the accompanying drawings.

The method for recording digital data streams on the HD-DVD, which has larger storage capacity than DVD+R/-R, will now be described first.

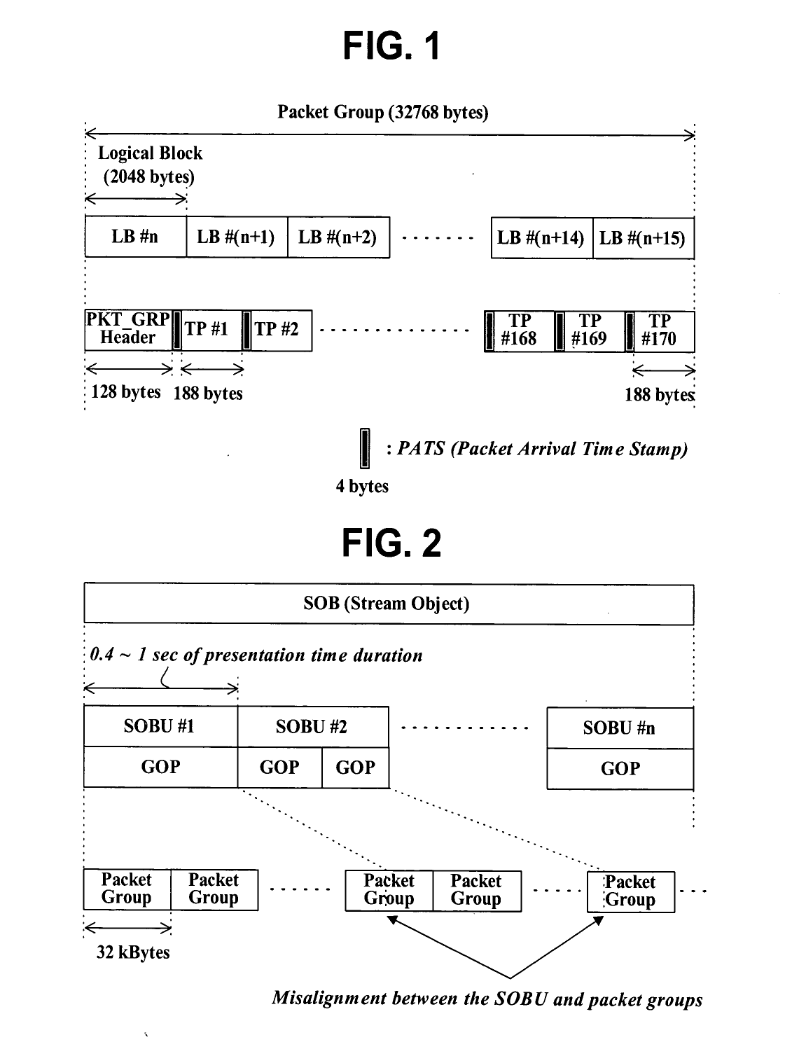

FIG. 1 illustrates the structure of an HD-DVD transport stream. Each packet group (recording block) has a size of 32,768 bytes. Because the packet group is the basic unit of data encoding with error correction code (ECC), it is necessary to read a whole packet group and perform error correction to retrieve original data recorded on the HD-DVD.

One packet group (recording block) consists of 16 logical blocks. A logical block is the basic unit of data read or data write. As shown in FIG. 1, one packet group, which is 32,768 bytes long, consists of 1 packet group header and 170 transport packets (TPs). The length of a packet group header is 128 bytes and the length of a transport packet is 188 bytes. When a transport packet is recorded on the HD-DVD, a 4-byte packet arrival time stamp (PATS) indicative of the arrival time of the transport packet is added to the transport packet. As a result, 170 transport packets with packet arrival time stamps and 1 packet group header constitute one packet group of a size of 32,768 bytes.

If a broadcast program is recorded on the HD-DVD, packet groups the number of which corresponds to the size of the broadcast program are created as shown in FIG. 2 and navigation information for accessing the recorded program is created. The navigation information manages the recorded program as a single stream object (SOB) and includes information on navigation units of the recorded program for random access. As shown in FIG. 2, one navigation unit, which is called a stream object unit (SOBU), is one data section comprising at least one group of pictures (GOP) defined in the MPEG standard and having a presentation duration of 0.4˜1 second. A search operation on a stream object (SOB) recorded on the HD-DVD is performed on a stream object unit (SOBU) basis.

As exemplified in FIG. 2, the size of data contained in stream object unit (SOBU) is not usually 31,960 bytes (=32768−170*4 (PATS)−128 (header)). Because the size of data contained in one packet group except the packet arrival time stamps (PATSs) and packet header is 31,960 bytes, stream object units (SOBUs) are not usually aligned with packet groups.

Because each stream object unit (SOBU) comprises at least one GOP, which starts with an I-picture defined by the MPEG, it is necessary to identify each of the stream object unit (SOBU) data sections for trick plays. As stream object units (SOBUs) are not aligned with packet groups, navigation information requires information on the misalignment between stream object units (SOBUs) and packet groups. In addition, because the first I-picture in each stream object unit (SOBU) is not aligned on a packet group boundary, information on the misalignment between I-pictures and packet groups is also required for reliable decoding in the case of trick plays.

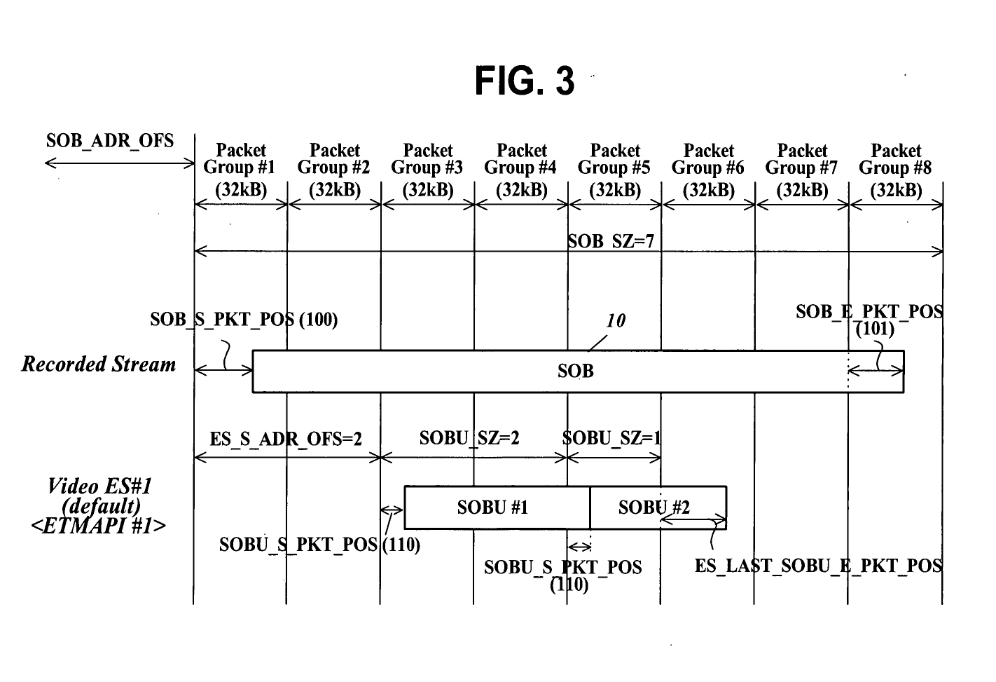

FIG. 3 shows an example of a data stream (e.g., digital broadcast program) recorded on the HD-DVD, wherein the recorded program 10 is not aligned with packet groups and the navigation units of the recorded program 10 are not aligned with packet groups, either. The recorded program 10 is managed as a single stream object (SOB) by the navigation information. The amount of misalignment between the beginning and end of the stream object (SOB) and packet group boundaries are written in the fields of SOB_S_PKT_POS 100 and SOB_E_PKT_POS 101, respectively. The two fields are included in the management information for the stream object (SOB). The amount of misalignment between the beginning of each stream object unit (SOBU) and the beginning of the first packet group containing the stream object unit (SOBU) is written in the SOBU_S_PKT_POS field 110 of the management information for the stream object unit (SOBU). The information on the misalignment is created for each of the stream object units (SOBUs) and thereby allows fast identification of the position of an arbitrary stream object unit (SOBU).

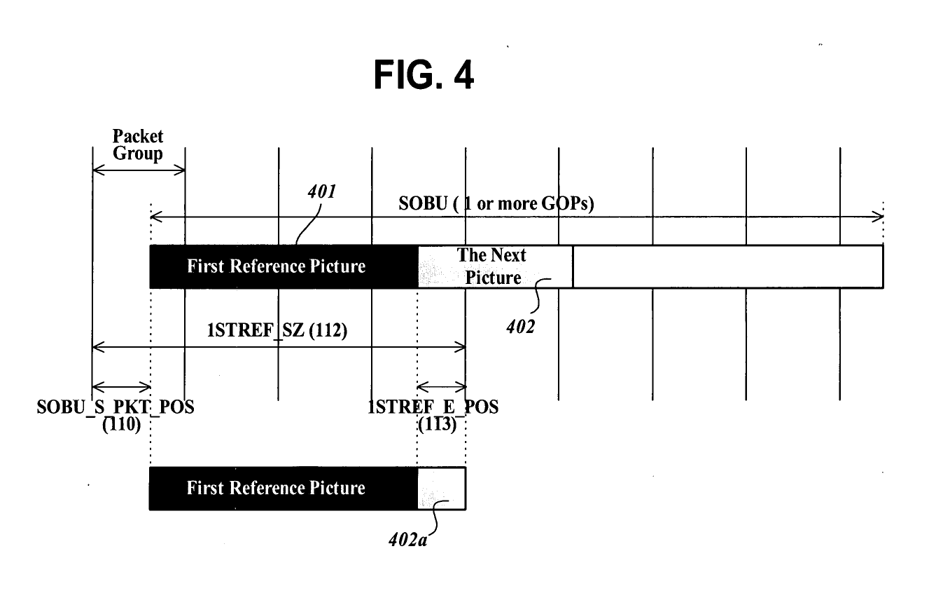

In some cases, it is necessary to decode only the first I-picture of a stream object unit (SOBU) instead of the whole stream object unit (SOBU). For example, in trick plays decoding of the first I-picture in every stream object unit (SOBU) or every several stream object units (SOBUS) is required. As shown in FIG. 4, the first I-picture of each stream object unit (SOBU) is not aligned with packet groups, either. As a result, if the fragment 402a of the picture 402 following the first I-picture 401 is decoded together with the first I-picture 401, a decoding problem may occur. In particular, if the following picture 402 is an I-picture, this will result in a serious problem in decoding the following data.

Consequently, information on the exact location of the first I-picture in each stream object unit (SOBU) is needed. The start position of the first I-picture of a stream object unit (SOBU) can be obtained from the SOBU_S_PKT_POS field 110 which indicates the offset of the stream object unit (SOBU) from the corresponding packet group boundary. Therefore, information on the size of the reference picture and the misalignment between the end position of the reference picture and the corresponding packet group boundary is additionally required. The information is written in the fields 1STREF_SZ 112 and 1STREF_E_POS 113. The size information written in the 1STREF_SZ field 112 is expressed in terms of the number of packet groups and the position information written in the 1STREF_E_POS field 113 is expressed in terms of the number of transport packets.

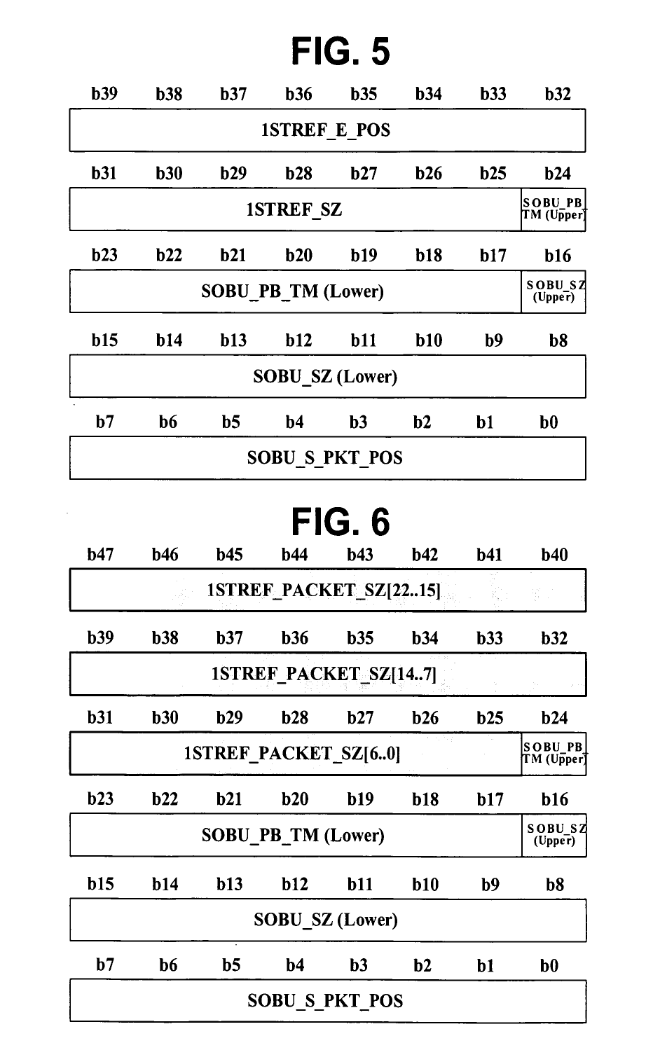

To locate a stream object unit (SOBU) exactly within the stream object (SOB), information on the size and presentation time duration of the stream object unit (SOBU) as well as the position information is required. The management information for a stream object unit (SOBU) entry is of the structure shown in FIG. 5. The management information is called the time map of the stream object unit (SOBU) entry because time-based search operations can be performed using the information.

If an arbitrary time t is given by the user, the presentation time (PTi) stored in the SOBU_PB_TM field of the management information for each stream object unit (SOBU) entry is summed to find the last stream object unit (SOBU) that makes the sum closest to the given time t without exceeding it. Then the size information stored in the SOBU_SZ field of every stream object unit (SOBU) preceding the found stream object unit (SOBU) is summed. The position reached by skipping packet groups by the sum (in size) from the beginning of the stream object (SOB) corresponds to the start position of the stream object unit (SOBU) having presentation time t given by the user.

The time map for each stream object unit (SOBU) shown in FIG. 5 has a size of 5 bytes and has the fields of SOBU_S_PKT_POS specifying the offset of the start position of the stream object unit (SOBU) from the corresponding packet group boundary, SOBU_SZ specifying the size of the stream object unit (SOBU), SOBU_PB_TM specifying presentation time of the stream object unit (SOBU), 1STREF_SZ specifying the size of the first reference picture in terms of the number of packet groups, and 1STREF_E_POS specifying the offset of the end position of the stream object unit (SOBU) from the corresponding packet group boundary. The data section of the first I-picture of the stream object unit (SOBU) is exactly specified by the fields 1STREF_SZ, SOBU_S_PKT_POS, and 1STREF_E_POS.

Navigation information including the time map shown in FIG. 5 is loaded from the HD-DVD into an internal memory of a reproducing apparatus for reproduction of the recorded data. Since it is common that a maximum of 32 bits can be written or read in one read/write operation, the size 5 bytes is not appropriate in view of efficient programming for navigation. It is advantageous, therefore, to make the size of the time map an even number as shown in FIG. 6.

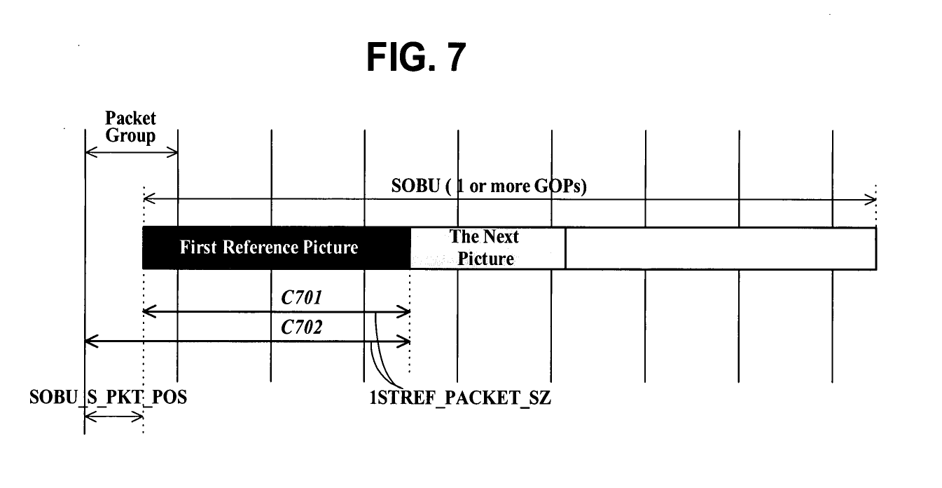

The embodiment shown in FIG. 6 assigns 23 bits to the 1STREF_PACKET_SZ field for storing the size of the first reference picture in each stream object unit (SOBU), wherein the size is written in terms of the number of transport packets instead of the number of packet groups. If the 1STREF_PACKET_SZ field indicates the actual size of the first picture (C701) as shown in FIG. 7, the field can store the size of an I-picture recorded across up to 49,345 packet groups because 232 is 8,388,608 and one packet group can accommodate 170 transport packets. If the 1STREF_PACKET_SZ field indicates the size from the beginning of the first packet group containing the first reference picture to the end of the picture (C702), the maximum size that the field can represent is reduced slightly (by up to 169 transport packets).

Instead of recording information on the end position of each stream object unit (SOBU) in the time map associated with the stream object unit (SOBU), it is also possible to record the information in the 128-byte packet group header added to each packet group.

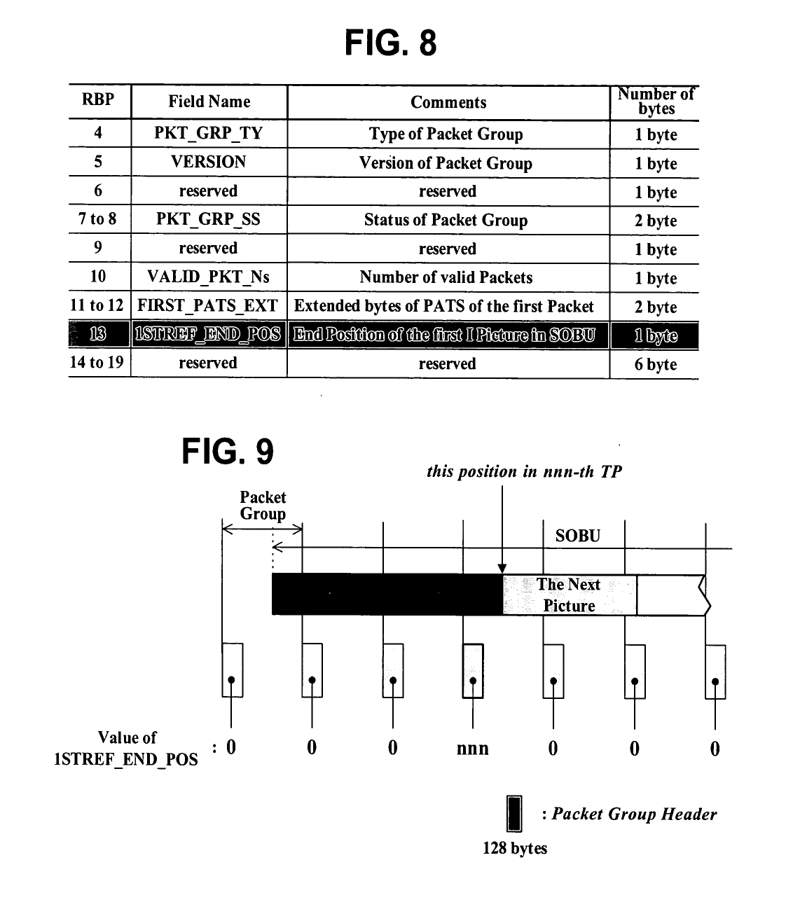

FIG. 8 illustrates the general information contained in the packet group header, wherein the 1-byte (=8 bits) 1STREF_END_POS field for specifying the end position of the first reference picture is included. The general information in FIG. 8 additionally includes PKT_GRP_TYPE field specifying the packet group type, VERSION field specifying the packet group version, PKT_GRP_SS field specifying the packet group status, VALID_PKT_Ns field specifying the number of valid packets, and FIRST_PATS_EXT field which is the extension byte of the packet arrival time stamp (PATS) of the first packet. These fields are not the concern of the present invention and thus will not be described.

If a packet group contains the last data of the first reference picture of a stream object unit (SOBU), the number of the transport packet containing the last data (a number between 1 and 170) is written in the 1STREF_END_POS field contained in the packet group header. If not, 0 is written in the 1STREF_END_POS field. FIG. 9 illustrates an example showing the values of the 1STREF_END_POS field in several successive packet groups.

In the embodiment shown in FIG. 8, the time map for each stream object unit (SOBU) has a size of 4 bytes because the 1STREF_END_POS field is removed from the time map shown in FIG. 5. In this embodiment, the start position of the first picture in each stream object unit (SOBU) is pointed to by the SOBU_S_PKT_POS field and the end position thereof is pointed to by the 1STREF_END_POS field. Consequently, the 7-bit 1STREF_SZ field, which has the size of the first picture expressed in terms of the number of packet groups, is used only for fast access to the data section containing the first picture data and the exact boundaries of transport packet group containing the first picture data within packet groups are identified by the SOBU_S_PKT_POS and 1STREF_END_POS fields.

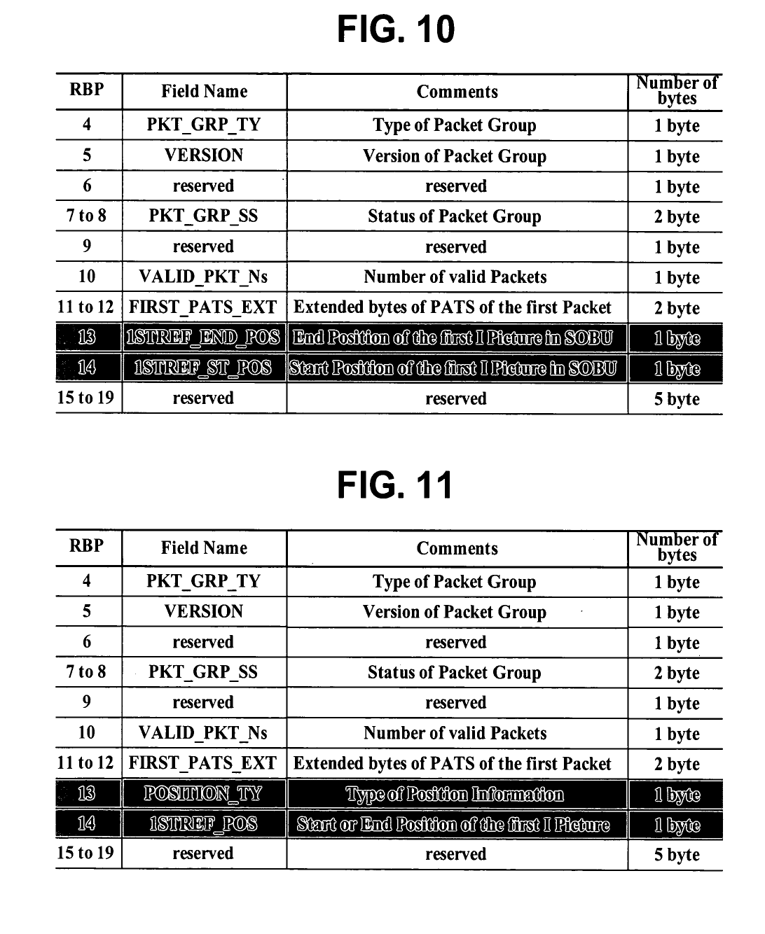

In another embodiment of the invention shown in FIG. 10, the 1STREF_ST_POS field indicating the start position of the first picture in a stream object unit (SOBU) is added to the general information in the packet group header. As in the 1STREF_ST_POS field, if a packet group contains the start data of the first I-picture in a stream object unit (SOBU), the number of the transport packet containing the first data of the I-picture (a number between 1 and 170) is written in the field. A value of 0 indicates that the packet group does not contain the start data of the first I-picture.

In yet another embodiment of the invention shown in FIG. 11, the general information of the packet group header has a position information field in which either the start or end position of the first I-picture in a stream object unit (SOBU) can be written and another field for indicating the type of the data stored in the position information field. In FIG. 11, the position information field is 1STREF_POS. If the type field has a value of 1, it indicates that the information written in the 1STREF_POS field is the start position of the I-picture. Likewise, if the type field has a value of 2, it indicates that the information written in the 1STREF_POS field is the end position. A value of 0 indicates that the packet group contains neither the start data nor the end data of the first reference picture.

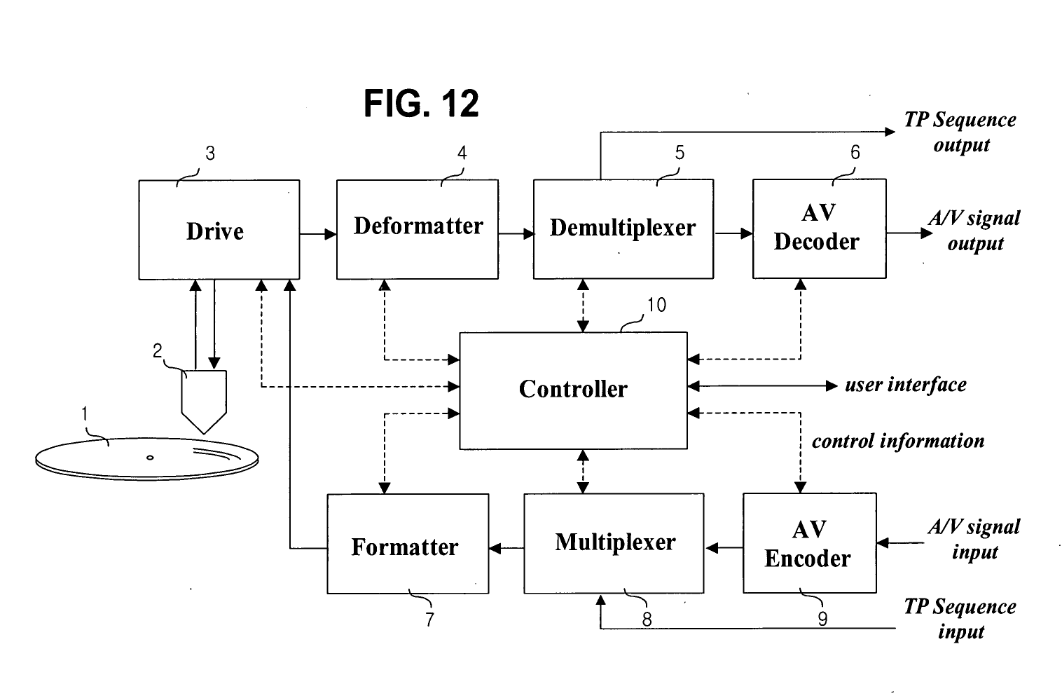

FIG. 12 illustrates a block diagram of an optical disk recording/reproducing apparatus in which the present invention may be advantageously embodied. An A/V encoder 9 encodes input audio and video signals in the MPEG format and outputs the encoded data with coding information and stream property information to a multiplexer 8. The multiplexer 8 multiplexes the input audio and video streams into a single transport stream based on the coding information and stream property information from the A/V encoder 9. In the case where transport streams are directly inputted to the multiplexer 8, the multiplexer 8 analyzes the data carried in the payload of each transport packet by demultiplexing the input transport streams and generates an output transport stream through analysis of information contained in higher levels (e.g., PES packet level, picture level, GOP level, etc). Receiving the transport stream from the multiplexer 8, a formatter 7 outputs data for recording by formatting the input transport stream with possible data alignment and addition of error correction code. As shown in FIG. 12, the operation of the A/V encoder 9, the multiplexer 8, and the formatter 7 is supervised by a controller 10. Receiving user input, the controller 10 sends necessary control information to the A/V encoder 9, the multiplexer 8, and the formatter 7. Also, the controller 10 controls a driver 3 so that the output of the formatter 7 can be recorded on an optical disk 1 (e.g., HD-DVD) as shown in FIG. 1. The controller 10 organizes the input transport stream into navigation units and records the navigation units in packet groups on the optical disk 1 by controlling the driver 3.

During the recording process, the controller 10 creates navigation information for presentation of the data being recorded. In the case where input analog A/V signals are recorded after being encoded by the A/V encoder 9, the controller 10 creates navigation information based on information on the encoded pictures provided by the encoder 9 and multiplexer 8. In the case where transport streams directly inputted to the multiplexer 8 are recorded, the controller 10 creates navigation information based on information that the multiplexer 8 analyzed. The controller 10 records the created navigation information as shown in FIGS. 5, 6, and/or 8 (or 10 or 11) on the optical disk 1 via the driver 3 and an optical pickup 2.

The controller 10 records the navigation information for each stream object unit (SOBU) shown in FIG. 5 or FIG. 6 in the navigation data area of the optical disk 1 by controlling the driver 3. The packet group header information shown in FIG. 8 is created for every 170 transport packets and provided to the formatter 7 and thereby recorded in the data area of the optical disk 1.

The controller 10 organizes the encoded picture data into stream object units (SOBUs), which are the basic navigation units, and discovers the size of the first I-picture in each stream object unit (SOBU) based on GOP-level and picture-level information provided by the A/V encoder 9. Likewise, the controller 10 organizes digital data directly inputted to the multiplexer 8 into stream object units (SOBUs) by finding the start position of each GOP based on information provided by the multiplexer 8. During the recording process, the controller 10 organizes one or more successive GOPs into a stream object unit (SOBU) so that the presentation time of the created stream object unit (SOBU) can be between 0.4 and 1 second. Also, the controller 10 discovers the size of the first I-picture in each stream object unit (SOBU) based on the provided information and writes the size of the first I-picture and/or the end position (and/or start position) thereof within a packet group in the data structure shown in FIGS. 5, 6, or 8 (or 10 or 11). If the size of the first reference picture is unknown during the encoding process, the fields 1STREF_SZ and 1STREF_E_POS in the embodiment of FIG. 5, the 1STREF_PACKET_SZ field in the embodiment of FIG. 6, the 1STREF_END_POS field in the embodiment of FIG. 8, the 1STREF_ST_POS field in the embodiment of FIG. 10, and the POSITION_TY field in the embodiment of FIG. 11 are set to 0.

During data reproduction, the controller 10 controls the driver 3 to reproduce data recorded on the optical disk 1. For reproducing data, it is necessary to load navigation data recorded thereon into a memory (not illustrated) of the reproducing apparatus first. Based on the loaded navigation information and user input received through a user interface (e.g., buttons, remote controller, etc), the controller 10 controls the driver 3 to read recorded recording blocks (packet groups) from the optical disk 1. The user input can specify a recorded program to read, which is managed as a single stream object (SOB) by the navigation information. The user input can be entered through a pre-programmed graphical user interface. The controller 10 handles the reproduction of the specified program using the user input and loaded navigation information.

A deformatter 4 receives a data stream reproduced by the driver 3 and the optical pickup 2 and reconstructs recording blocks (packet groups) and extracts the packet header information and 170 transport packets from each packet group. The obtained header information is provided to the controller 10. A demultiplexer 5 demultiplexes the sequence of transport packets into audio and video data. If the operating mode is set to digital stream transfer mode by the controller 10, the demultiplexer 5 passes the input transport stream through a digital interface such as IEEE 1394. An A/V decoder 6 decodes encoded audio and video data to retrieve original audio and video signals. During the reproduction process, the operation of the deformatter 4, demultiplexer 5, and A/V decoder 6 is supervised by the controller 10.

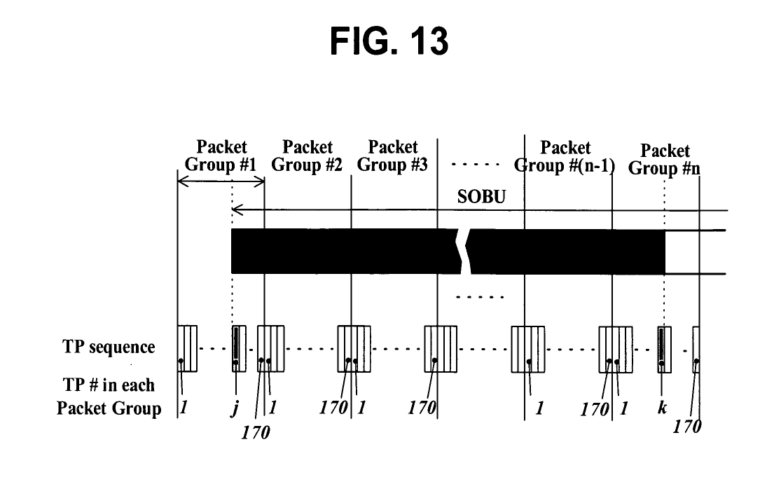

During playback or search operation, the data section of each stream object unit (SOBU) is specified by the values written in the SOBU_SZ and SOBU_PB_TM fields. The rough size (1STREF_SZ) or precise size (1STREF_PACKET_SZ) and position of the first reference picture in each stream object unit (SOBU) are specified by the information shown in FIGS. 5, 6, or 8 (or 10 or 11). When decoding the first reference picture shown in FIG. 13, the controller 10 controls the deformatter 4 so that only the transport packets carrying the first reference picture data can be transmitted to the demultiplexer 5. As a result, the j-th through 170th transport packets of Packet Group #1, all transport packets of Packet Group #2˜Packet Group #n-1, and the first through k-th transport packets of Packet Group #n are provided to the demultiplexer 5. In the example shown in FIG. 13, the total number of transport packets transmitted to the demultiplexer 6 for decoding the first I-picture is (170-j+1)+(n-2)*170+k.

In another reproduction method of the embodiment shown in FIG. 1, the controller 10 sets a particular operating mode for the deformatter 4 in the case of trick plays wherein only I-pictures are presented. In the particular operating mode, if the value of the 1STREF_END_POS field of a packet group is not zero, the deformatter 4 transmits transport packets the sequential number of which is less than or equal to the value. If the value is zero, the deformatter 4 transmits all transport packets of the packet group. The controller 10 controls the deformatter 4 with reference to the value of the SOBU_S_PKT_POS field so that the deformatter 4 can identify the boundary between transport packets carrying the first I-picture and transport packets carrying other data in the packet group containing the start data of the first I-picture data.

In the embodiments shown in FIG. 11 and FIG. 12, the decoding of the first reference picture data in each stream object unit (SOBU) can be accomplished without the value of the SOBU_S_PKT_POS field because the information on the start position of the first picture exists in the packet group header. In the particular operating mode, if the value of 1STREF_ST_POS field or POSITION_TY field of the header of a packet group is not 0, the deformatter 4 passes transport packets from the transport packet that the value of the 1STREF_POS field indicates to the following stage. Transport streams preceding the transport packet are all skipped.

The apparatus shown in FIG. 12 can both record data and reproduce data. However, the present invention can be embodied by a recording-only apparatus or playback-only apparatus comprising some components shown in FIG. 12.

At least one embodiment according to the present invention can specify the data section of the first reference picture in each navigation unit precisely, thereby preventing decoding errors in the case of track plays wherein only the first reference picture in each navigation unit is decoded.

While the invention has been disclosed with respect to a limited number of embodiments, those skilled in the art, having the benefit of this disclosure, will appreciate numerous modifications and variations therefrom. It is intended that all such modifications and variations fall within the spirit and scope of the invention.

1. A method for recording video data and management information for the video data on a recording medium, comprising the steps of:
(a) recording the video data in a plurality of recording blocks on the recording medium while organizing the recorded video data into navigation units; and
(b) recording size information of first picture data included in each navigation unit as management information for each navigation unit, wherein the size information being expressed in terms of number of transport packets.

2. The method set forth in claim 1, wherein size of the recording block is 32,768 bytes.

3. The method set forth in claim 1, further comprising the step of creating 128-byte block header information for each of the recording blocks and adding the block header information in front area of each recording block.

4. The method set forth in claim 1, wherein each of the navigation units comprises at least one group of picture (GOP) defined by MPEG.

5. The method set forth in claim 1, wherein the first picture data is intra-coded picture data defined by MPEG.

6. The method set forth in claim 1, wherein length of the transport packet is 188 bytes.

7. The method set forth in claim 1, wherein the size information is sequence number of a transport packet containing last data of the first picture data.

8. The method set forth in claim 1, wherein the size information is recorded with zero if size of the first picture data is unknown.

9. The method set forth in claim 1, wherein if an input signal is not a sequence of transport packets, said step (a) encodes the input signal into a sequence of transport packets and records the sequence of transport packets in a plurality of recording blocks on the recording medium while organizing the recorded data into navigation units.

10. An apparatus for recording video data and management information for the video data on a recording medium, comprising:
a driver for driving optical recording means for recording signals on the recording medium;
a formatter for organizing input data including the video data into recording blocks of the recording medium;
means for analyzing header information included in the video data; and
a controller,
wherein the controller organizes the video data into a plurality of navigation units based on the analyzed header information, creates size information on first picture data included in each of the navigation units, and controls the driver so that the size information is recorded as management information for each corresponding navigation unit, wherein the size information is expressed in terms of number of transport packets.

11. The apparatus set forth in claim 10, wherein the size information is sequence number of a transport packet containing last data of the first picture data.

12. The apparatus set forth in claim 10, wherein the controller sets the size information to 0 if size of the first picture data is not known from the analyzed header information.

13. The apparatus set forth in claim 10, further comprising an encoder for encoding an input signal into a sequence of transport packets and for providing the encoded data to the formatter if the input signal is not a sequence of transport packets.

14. The apparatus set forth in claim 13, wherein the controller organizes the video data into a plurality of navigation units based on information provided by the encoder, creates size information on first picture data in each of the navigation units, and controls the driver so that the size information is recorded as management information for each corresponding navigation unit, the size information being expressed in terms of number of transport packets carrying the first picture data.

15. A method for reproducing video data incorporated in a sequence of transport packets from a recording medium based on management information for the video data, comprising the steps of:
(a) specifying a navigation unit based on size and presentation time duration of each of navigation units contained in the management information;
(b) identifying a block of transport packets carrying first picture data in the specified navigation unit from the sequence of transport packets based on size information on the first picture data contained in the management information; and
(c) decoding or outputting the identified block of transport packets,
wherein the size information is expressed in terms of number of transport packets.

16. The method set forth in claim 15, wherein the size information is sequence number of a transport packet containing last data of the first picture data.

17. An apparatus for reproducing video data incorporated in a sequence of transport packets from a recording medium based on management information for the video data, comprising:
a driver for driving optical reproduction means for reproducing data recorded on the recording medium;
storage means for storing the management information read by the optical reproduction means; and
a controller for specifying a navigation unit based on size and presentation time duration of each of navigation units contained in the stored management information, for controlling the driver to read at least first picture data in the specified navigation unit based on size information, contained in the management information, on the first picture data in the specified navigation unit, and for providing the transport packets carrying the first picture data to a decoder or outputting the transport packets carrying the first picture data,
wherein the size information is expressed in terms of number of transport packets.

18. The apparatus set forth in claim 17, wherein the size information is sequence number of a transport packet containing last data of the first picture data.

19. A method for recording video data and management information for the video data on a recording medium, comprising the steps of:
(a) recording the video data in a plurality of recording blocks on the recording medium while organizing the recorded video data into navigation units;
(b) adding header information in front area of each of the recording blocks; and
(c) writing information on position of last data of first picture in each of the navigation units in the header information of a recording block containing the last data.

20. The method set forth in claim 19, wherein the size of the recording block is 32,768 bytes.

21. The method set forth in claim 19, wherein the size of the header information is 128 bytes.

22. The method set forth in claim 19, wherein each of the navigation units comprises at least one group of picture (GOP) defined by MPEG.

23. The method set forth in claim 19, wherein the first picture data is intra-coded picture data defined by MPEG.

24. The method set forth in claim 19, wherein the position information is sequential number of a transport packet carrying the last data, the sequential number starting from 1 within the recording block.

25. The method set forth in claim 24, wherein length of the transport packet is 188 bytes.

26. The method set forth in claim 19, wherein size of the position information is 1 byte.

27. The method set forth in claim 19, further comprising the step of writing zero in a field allocated for the position information in the header information of recording blocks that do not contain the last data of the first picture data in each of the navigation units.

28. The method set forth in claim 19, wherein if an input signal is not a sequence of transport packets, said step (a) encodes the input signal into a sequence of transport packets and records the sequence of transport packets in a plurality of recording blocks on the recording medium while organizing the recorded data into navigation units.

29. The method set forth in claim 19, further comprising the step of writing information on start position of first picture data in each of the navigation units in header information of a recording block that contains starting data of the first picture data.

30. The method set forth in claim 29, further comprising the step of writing information indicating whether the header information contains position information on the starting data or position information on the last data.

31. An apparatus for recording video data and management information for the video data on a recording medium, comprising:
a driver for driving optical recording means for recording signals on the recording medium;
a formatter for organizing input data including the video data into recording blocks of the recording medium;
means for analyzing header information included in the video data; and
a controller,
wherein the controller organizes the video data into a plurality of navigation units based on the analyzed header information, creates size information on first picture data included in each of the navigation units, adds header information in front area of each of the recording blocks organized by the formatter, and writes information on position of last data of first picture in each of the navigation units in the header information of a recording block containing the last data.

32. The apparatus set forth in claim 31, wherein the position information is sequential number of a transport packet carrying the last data, the sequential number starting from 1 within the recording block.

33. The apparatus set forth in claim 31, wherein size of the position information is 1 byte.

34. The apparatus set forth in claim 31, wherein the controller writes zero in a field allocated for the position information in the header information of recording blocks that do not contain the last data of the first picture data in each of the navigation units.

35. The apparatus set forth in claim 31, wherein size of the header information of the recording block is 128 bytes.

36. The apparatus set forth in claim 31, further comprising an encoder for encoding an input signal into a sequence of transport packets and for providing the encoded data to the formatter if the input signal is not a sequence of transport packets.

37. The apparatus set forth in claim 31, wherein the controller further writes information on start position of first picture data in each of the navigation units in header information of a recording block that contains starting data of the first picture data.

38. The apparatus set forth in claim 37, wherein the controller further writes information indicating whether the header information contains position information on the starting data or position information on the last data.

39. A method for reproducing video data incorporated in a sequence of transport packets recorded in a plurality of recording blocks from a recording medium based on management information for the video data, comprising the steps of:
(a) specifying a navigation unit based on size and presentation time duration of each of navigation units contained in the management information;
(b) identifying a block of transport packets, from the sequence of transport packets, from a first transport packet carrying starting data of first picture data in the specified navigation unit to a second transport packet carrying last data of the first picture data, wherein the first transport packet is indicated by start information included in the management information and the second transport packet is indicated by end information included in header information of a recording block; and
(c) decoding or outputting the identified block of transport packets.

40. The method set forth in claim 39, wherein the end information is sequential number of the transport packet carrying the last data, the sequential number starting from 1 within the recording block.

41. The method set forth in claim 39, wherein size of the end information is 1 byte.

42. The method set forth in claim 39, wherein a field allocated for the end information in header information of each of the recording blocks is set to 0 if the recording block does not contain last data of first picture data in each of the navigation units.

43. A method for reproducing video data incorporated in a sequence of transport packets recorded in a plurality of recording blocks from a recording medium based on management information for the video data, comprising the steps of:
(a) specifying a navigation unit based on size and presentation time duration of each of navigation units contained in the management information; and
(b) from contiguous recording blocks in which at least a part of the specified navigation unit is recorded, identifying a block of transport packets from a first transport packet carrying starting data of first picture data in the specified navigation unit to a second transport packet carrying last data of the first picture data, and decoding or outputting the identified block of transport packets, wherein the first transport packet is indicated by start information included in header information of a recording block and the second transport packet is indicated by end information included in header information of another recording block.

44. An apparatus for reproducing video data incorporated in a sequence of transport packets recorded in a plurality of recording blocks from a recording medium based on management information for the video data, comprising:
a driver for driving optical reproduction means for reproducing data recorded on the recording medium;
storage means for storing the management information read by the optical reproduction means; and
a controller for specifying a navigation unit based on size and presentation time duration of each of navigation units contained in the stored management information, for controlling the driver to read at least first picture data in the specified navigation unit based on size information, contained in the management information, on the first picture data in the specified navigation unit, and for providing to a decoder or outputting the read data up to a transport packet located at an end position of the first picture data, the end position being indicated by header information of one of the recording blocks.

45. The apparatus set forth in claim 44, wherein information on the end position is sequential number of the transport packet carrying last data of the first picture data, the sequential number starting from 1 within said one recording block.

46. The apparatus set forth in claim 44, wherein size of information on the end position is 1 byte.

47. The apparatus set forth in claim 44, wherein a field allocated for the end position in header information of each of the recording blocks is set to 0 if the recording block does not contain last data of first picture data in each of the navigation units.

48. An apparatus for reproducing video data incorporated in a sequence of transport packets recorded in a plurality of recording blocks from a recording medium based on management information for the video data, comprising:
a driver for driving optical reproduction means for reproducing data recorded on the recording medium;
storage means for storing the management information read by the optical reproduction means; and
a controller for specifying a navigation unit based on size and presentation time duration of each of navigation units contained in the stored management information, for controlling the driver to read successive recording blocks in which at least a part of the specified navigation unit is recorded, for providing to a decoder or outputting a block of transport packets from a first transport packet located at a start position of first picture data in the specified navigation unit to another transport packet located at an end position of the first picture data in the specified navigation unit, wherein the start position is indicated by start information included in header information of a recording block and the end position is indicated by end information included in header information of another recording block.
